(19) United States
(12) Patent Application Publication
(10) Pub. No.: US 2020/0111493 A1
(43) Pub. Date: Apr. 9, 2020

(54) SPEECH RECOGNITION DEVICE AND SPEECH RECOGNITION METHOD

(71) Applicant: Mitsubishi Electric Corporation, Tokyo (JP)

(72) Inventors: Takumi TAKEI, Tokyo (JP); Takayoshi CHIKURI, Tokyo (JP)

(73) Assignee: Mitsubishi Electric Corporation, Tokyo (JP)

(21) Appl. No.: 16/495,640

(22) PCT Filed: May 25, 2017
(86) PCT No.: PCT/JP2017/019606

§ 371 Date: Sep. 19, 2019

(51) Int. Cl. G10L 15/25; G10L 15/183; G10L 15/22; G06F 3/16

(52) U.S. Cl. CPC G10L 15/25; G10L 15/183; G10L 2015/088; G06F 3/167; G10L 15/22

(57) ABSTRACT

Included here are: a speech recognition unit for performing speech recognition on a speaker's speech; a keyword extraction unit for extracting a preset keyword from a result of the speech recognition; a conversation determination unit for referring to a keyword extraction result and determining whether or not the speaker's speech is a conversation; and an operation command extraction unit for extracting a command for operating an apparatus from the speech recognition result when the speech is determined not to be a conversation, and not extracting the command from the speech recognition result when the speech is determined to be a conversation.

### TECHNICAL FIELD

The present invention relates to a technique for performing speech recognition on a speaker's speech, to thereby extract information for controlling an apparatus.

### BACKGROUND ART

Heretofore, techniques have been used for reducing occurrence of false recognition at the time of determining, when speeches of multiple speakers are present, whether the speech of each of the speakers is a speech for instructing an apparatus how to make control or a speech for a conversation between the speakers.

For example, in Patent Literature 1, a speech recognition device is disclosed which, when having detected speaker's speeches of multiple speakers within a previous specified time period, determines that the speaker's speeches are those for constituting a conversation, and does not perform predetermined-keyword detection processing.

### CITATION LIST

### Patent Literature

Patent Literature 1: Japanese Patent Application Laid-open No.2005-157086

### SUMMARY OF INVENTION

### Technical Problem

According to the speech recognition device described in Patent Literature 1, by use of multiple sound collection means, a speaker's speech of a certain speaker is detected and if, within the specific time period after detection of that speaker's speech, it is detected that a speaker's speech of another speaker is collected, a conversation between these speakers is detected. Thus, there is a problem in that the multiple sound collection means are required. Further, it is required to wait for the specific time period in order to detect a conversation between the speakers, so that there is a problem in that a delay occurs also for the predetermined-keyword detection processing, resulting in reduced operability.

This invention has been made to solve the problems as described above, and an object thereof is to reduce false recognition of a speaker's speech without requiring multiple sound collection means, and to perform extraction of an operation command for operating an apparatus, without setting such a delay time.

### Solution to Problem

A speech recognition device according to the invention comprises: a speech recognition unit for performing speech recognition on a speaker's speech; a keyword extraction unit for extracting a preset keyword from a recognition result of the speech recognition unit; a conversation determination unit for determining, with reference to an extraction result of the keyword extraction unit, whether or not the speaker's speech is a conversation; and an operation command extraction unit for extracting a command for operating an apparatus from the recognition result of the speech recognition unit when the conversation determination unit has determined that the speech is not a conversation, but not extracting the command from the recognition result when the conversation determination unit has determined that the speech is a conversation.

### ADVANTAGEOUS EFFECTS OF INVENTION

According to the invention, it is possible to reduce false recognition of the speaker's speech on the basis of speaker's speech collected by a single sound collection means. Further, it is possible to perform extraction of the operation command for operating an apparatus, without setting the delay time.

### BRIEF DESCRIPTION OF DRAWINGS

FIG. 1 is a block diagram showing a configuration of a speech recognition device according to Embodiment 1 of the invention.

FIG. 2A and FIG. 2B are diagrams each showing a hardware configuration example of the speech recognition device.

FIG. 3 is a flowchart showing operations in speech recognition processing by the speech recognition device according to Embodiment 1.

FIG. 4 is a flowchart showing operations in conversation determination processing by the speech recognition device according to Embodiment 1.

FIG. 5 is a diagram showing another configuration of the speech recognition device according to Embodiment 1.

FIG. 6 is a diagram showing a display example of a display screen of a display device connected to the speech recognition device according to Embodiment 1.

FIG. 7 is a block diagram showing a configuration of a speech recognition device according to Embodiment 2.

FIG. 8 is a flowchart showing operations in conversation determination processing by the speech recognition device according to Embodiment 2.

FIG. 9 is a block diagram showing a configuration of a speech recognition device according to Embodiment 3.

FIG. 10 is a flowchart showing operations in keyword registration processing by the speech recognition device according to Embodiment 3.

FIG. 11 is a block diagram showing an example in the case where a speech recognition device and a server device serve in cooperation to provide the configuration according to Embodiment 1.

### DESCRIPTION OF EMBODIMENTS

Hereinafter, for illustrating the invention in more detail, embodiments for carrying out the invention will be described with reference to accompanying drawings.

### Embodiment 1

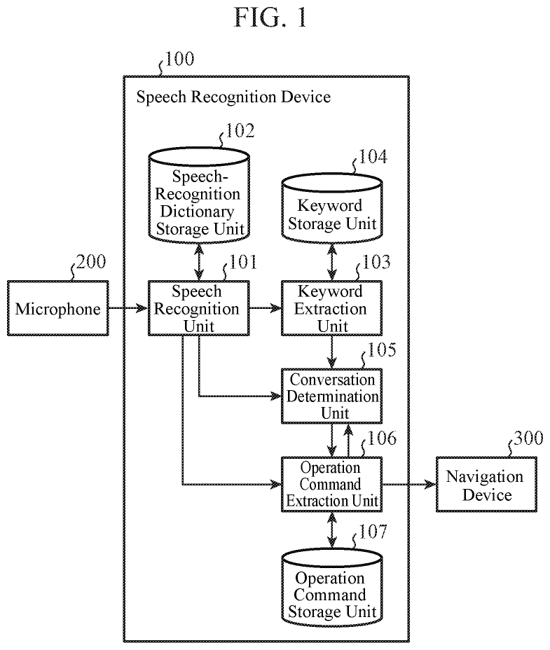

FIG. 1 is a block diagram showing a configuration of a speech recognition device 100 according to Embodiment 1.

The speech recognition device 100 includes a speech recognition unit 101, a speech-recognition dictionary storage unit 102, a keyword extraction unit 103, a keyword storage unit 104, a conversation determination unit 105, an operation command extraction unit 106, and an operation command storage unit 107.

As shown in FIG. 1, the speech recognition unit 100 is connected, for example, to a microphone 200 and a navigation device 300. Note that a control apparatus connected to the speech recognition device 100 is not limited to the navigation device 300.

The speech recognition unit 101 receives an input of a speaker's speech collected by the single microphone 200. The speech recognition unit 101 performs speech recognition on the inputted speaker's speech, and outputs an obtained recognition result to the keyword extraction unit 103, the conversation determination unit 105 and the operation command extraction unit 106.

In detail, the speech recognition unit 101 performs A/D (Analog/Digital) conversion on the speaker's speech, by using PCM (Pulse Code Modulation), for example, and then detects from the digitalized speech signal, a speech section corresponding to the content spoken by a user. The speech recognition unit 101 extracts speech data in the detected speech section or feature amounts of the speech data. Note that, depending on the environment in which the speech recognition device 100 is used, noise cancelling processing or echo cancelling processing by a spectral subtraction method or the like using signal processing, etc. may be executed before the feature amounts are extracted from the speech data.

With reference to a speech recognition dictionary stored in the speech-recognition dictionary storage unit 102, the speech recognition unit 101 performs recognition processing of the extracted speech data or the feature amounts of the speech data, to thereby obtain the recognition result. The recognition result obtained by the speech recognition unit 101 includes at least one of speech section information; a recognition-result character string; identification information, such as an ID or the like associated with the recognition-result character string, or a recognition score indicating its likelihood. Here, the recognition-result character string is a string of syllables, a word or a string of words. The recognition processing by the speech recognition unit 101 is performed with application of a usual method such as an HMM (Hidden Markov Model) method, for example.

A timing at which the speech recognition unit 101 should start the speech recognition processing can be set appropriately. For example, it is allowable to configure that when the user presses down a speech-recognition-start instruction button (not illustrated), a signal indicating detection of such pressing down is inputted to the speech recognition unit 101, and this causes the speech recognition unit 101 to start speech recognition.

The speech-recognition dictionary storage unit 102 has stored the speech recognition dictionary.

The speech recognition dictionary is a dictionary to be referred to by the speech recognition unit 101 at the time of performing speech recognition processing on the speaker's speech, in which words as objects of speech recognition are defined. For defining the words in the speech recognition dictionary, a usual method may be applied in which words are listed using BNF (Backus-Naur Form) notation, word strings are written in a network form using a network grammar, word chains or the like are modeled stochastically using a statistical language model, or the like.

Further, the speech recognition dictionary includes an already-prepared dictionary and a dictionary that is dynamically created as needed by the connected navigation device 300 in operation.

The keyword extraction unit 103 searches whether any keyword registered in the keyword storage unit 104 exists in the recognition-result character strings stated in the recognition result inputted from the speech recognition unit 101. When the registered keyword exists in the recognition-result character strings, the keyword extraction unit 103 extracts that keyword. The keyword extraction unit 103, when having extracted the keyword from the recognition-result character strings, outputs the extracted keyword to the conversation determination unit 105.

The keyword storage unit 104 stores each keyword that may appear in a conversation between speakers. Here, the conversation between speakers means, for example, in the case where the speech recognition device 100 is installed in a vehicle, a conversation between persons staying in the vehicle, a speech made by one person staying in the vehicle toward another person staying in the vehicle, or the like. Further, the keyword that may appear in the conversation between speakers is, for example, a personal name (a second name, a first name, a full name, a nickname or the like), a word indicating a call (“Hi”, “Hey”, “Say” or the like), or the like.

It is noted that, with respect to the personal name, if every personal name expected to appear in a conversation between speakers is stored as the keyword in the keyword storage unit 104, the probability increases that a speech, not the conversation between speakers, will be falsely detected as the conversation. For the purpose of avoiding such false detection, the speech recognition device 100 may perform processing of causing the keyword storage unit 104 to store, as a keyword, the personal name of a speaker who is pre-estimated from an image captured by a camera, an authentication result of a biometric authentication device, or the like. Instead, the speech recognition device 100 may perform processing of estimating a speaker on the basis of registration information such as an address book or the like, that is acquired by making connection with a mobile terminal owned by the speaker, a cloud service, or the like, and then causing the keyword storage unit 104 to store, as a keyword, the personal name of the estimated speaker.

The conversation determination unit 105, when the keyword extracted by the keyword extraction unit 103 is inputted thereto, refers to the recognition result inputted from the speech recognition unit 101 to thereby determine that the speech including the inputted keyword and its part following that keyword is a conversation between speakers. The conversation determination unit 105 outputs the determination result indicating that the speech is a conversation between speakers, to the operation command extraction unit 106.

Further, after determining that the speech is a conversation, the conversation determination unit 105 compares information indicating the speech section in the recognition result used for that determination, with information indicating a speech section in a new recognition result acquired from the speech recognition unit 101, to thereby estimate whether the conversation is continuing or the conversation has been terminated. The conversation determination unit 105, when having estimated that the conversation has been terminated, outputs information indicating termination of the conversation to the operation command extraction unit 106.

The conversation determination unit 105, when no keyword is inputted thereto from the keyword extraction unit 103, determines that the speech is not a conversation between speakers. The conversation determination unit 105 outputs the determination result indicating that the speech is not a conversation between speakers, to the operation command extraction unit 106.

The operation command extraction unit 106 refers to the determination result inputted from the conversation determination unit 105, and when the determination result indicates that the speech is not a conversation between speakers, extracts from the recognition result inputted from the speech recognition unit 101, a command (hereinafter, referred to as an operation command) for operating the navigation device 300. When a wording matched with or analogous to an operation command stored in the operation command storage unit 107 is included in the recognition result, the operation command extraction unit 106 extracts that wording as a corresponding operation command.

The operation command is exemplified by “Change Route”, “Search Restaurant”, “Start Recognition Processing” or the like, and the wording matched with or analogous to that operation command is exemplified by “Change Route”, “Nearby Restaurant”, “Start Speech Recognition” or the like. The operation command extraction unit 106 may extract an operation command from among wordings matched with or analogous to wordings of operation commands themselves prestored in the operation command storage unit 107, and may instead extract an operation command in such a manner that the aforementioned operation commands or parts of the aforementioned operation commands are extracted as keywords, and an operation command corresponding to the extracted keyword or a combination of extracted keywords is extracted. The operation command extraction unit 106 outputs the content of the operation indicated by the extracted operation command to the navigation device 300.

In contrast, the operation command extraction unit 106, when the determination result indicating that the speech is a conversation between speakers is inputted thereto from the conversation determination unit 105, does not extract any operation command from the recognition result inputted from the speech recognition unit 101, or corrects the recognition score stated in the recognition result to set so that the operation command is less likely to be extracted.

Specifically, the operation command extraction unit 106, assuming that a threshold value for the recognition score is preset therein, is configured to output the operation command to the navigation device 300 when the recognition score is equal to or more than the threshold value, and not to output the operation command to the navigation device 300 when the recognition score is less than the threshold value. The operation command extraction unit 106, when the determination result indicating that the speech is a conversation between speakers is inputted thereto from the conversation determination unit 105, sets the recognition score in the recognition result to a value less than the preset threshold value, for example.

The operation command storage unit 107 includes a region for storing the operation commands. The operation command storage unit 107 stores the wordings for operating apparatuses, such as “Change Route” and the like described above. Further, the operation command storage unit 107 may store pieces of information resulting from converting the wordings of the operation commands into forms interpretable by the navigation device 300, to be associated with their respective wordings. In that case, the operation command extraction unit 106 acquires from the operation command storage unit 107, the piece of information converted into the form interpretable by the navigation device 300.

Next, hardware configuration examples of the speech recognition device 100 will be described.

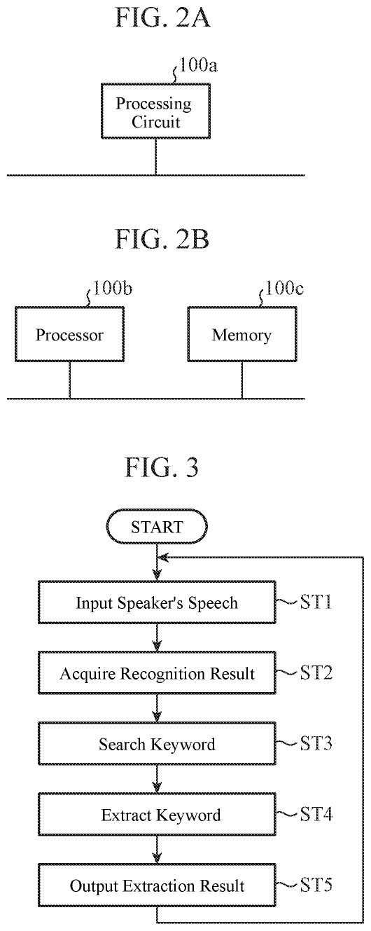

FIG. 2A and FIG. 2B are diagrams each showing a hardware configuration example of the speech recognition device 100.

The respective functions of the speech recognition unit 101, the keyword extraction unit 103, the conversation determination unit 105 and the operation command extraction unit 106 in the speech recognition device 100 are implemented by a processing circuit. Namely, the speech recognition device 100 includes the processing circuit for implementing the above respective functions. The processing circuit may be, as shown in FIG. 2A, a processing circuit 100a as dedicated hardware, and may be, as shown in FIG. 2B, a processor 100b which executes programs stored in a memory 100c.

When the speech recognition unit 101, the keyword extraction unit 103, the conversation determination unit 105 and the operation command extraction unit 106 are provided as dedicated hardware as shown in FIG. 2A, what corresponds to the processing circuit 100a is, for example, a single circuit, a composite circuit, a programmed processor, a parallel-programmed processor, an ASIC (Application Specific Integrated Circuit), an FPGA (Field-Programmable Gate Array) or any combination thereof. The functions of the respective units of the speech recognition unit 101, the keyword extraction unit 103, the conversation determination unit 105 and the operation command extraction unit 106 may be implemented by their respective processing circuits, and the functions of the respective units may be implemented collectively by one processing circuit.

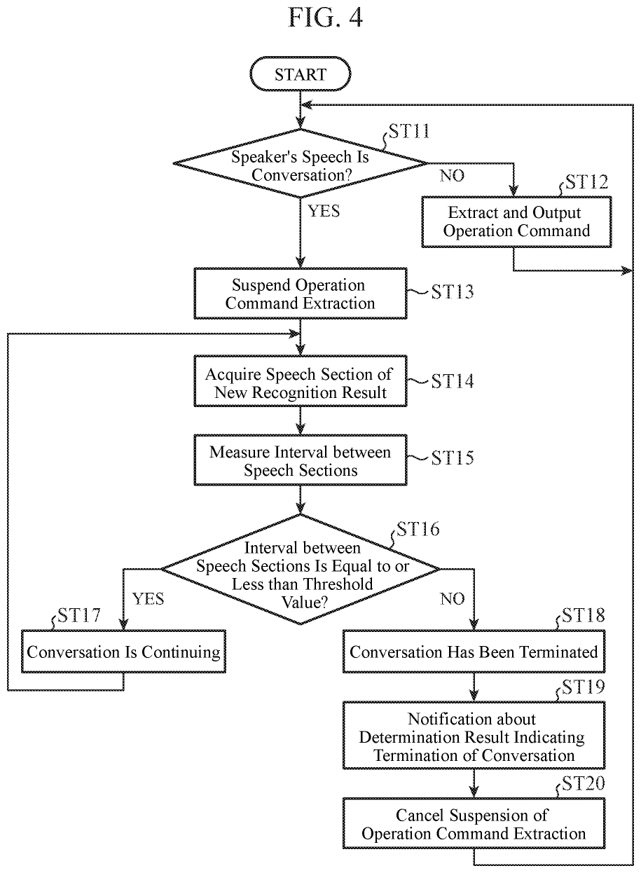

When the speech recognition unit 101, the keyword extraction unit 103, the conversation determination unit 105 and the operation command extraction unit 106 are provided as the processor 100b as shown in FIG. 2B, the functions of the respective units are implemented by software, firmware or a combination of software and firmware. The software or firmware is written as a program and is stored in the memory 100c. The processor 100b reads out and executes the programs stored in the memory 100c, to thereby implement the respective functions of the speech recognition unit 101, the keyword extraction unit 103, the conversation determination unit 105 and the operation command extraction unit 106. Namely, the speech recognition unit 101, the keyword extraction unit 103, the conversation determination unit 105 and the operation command extraction unit 106 are provided with the memory 100c for storing the programs by which, when they are executed by the processor 100b, as a result, the respective steps shown in FIG. 3 and FIG. 4 to be described later will be executed. Further, it can also be said that these programs are programs for causing a computer to execute steps or processes of the speech recognition unit 101, the keyword extraction unit 103, the conversation determination unit 105 and the operation command extraction unit 106.

Here, the processor 100b is, for example, a CPU (Central Processing Unit), a processing device, an arithmetic device, a processor, a microprocessor, a microcomputer, a DSP (Digital Signal Processor), or the like.

The memory 100c may be a non-volatile or volatile semiconductor memory such as, for example, a RAM (Random Access Memory), a ROM (Read Only Memory), a flash memory, an EPROM (Erasable Programmable ROM), an EEPROM (Electrically EPROM) or the like; may be a magnetic disk such as a hard disk, a flexible disk or the like; and may be an optical disc such as a mini disc, a CD (Compact Disc), a DVD (Digital Versatile Disc) or the like.

It is noted that the respective functions of the speech recognition unit 101, the keyword extraction unit 103, the conversation determination unit 105 and the operation command extraction unit 106 may be implemented partly by dedicated hardware and partly by software or firmware.

In this manner, the processing circuit 100a in the speech recognition device 100 can implement the respective functions described above, by hardware, software, firmware or any combination thereof.

Next, operations of the speech recognition device 100 will be described.

The operations of the speech recognition device 100 will be described separately for speech recognition processing and conversation determination processing.

First, with reference to the flowchart of FIG. 3, description will be made about the speech recognition processing.

FIG. 3 is the flowchart showing operations in the speech recognition processing by the speech recognition device 100 according to Embodiment 1.

The speech recognition unit 101, when a speaker's speech collected by the microphone 200 is inputted thereto (Step ST1), performs speech recognition on the inputted speaker's speech with reference to the speech recognition dictionary stored in the speech-recognition dictionary storage unit 102, to thereby acquire a recognition result (Step ST2). The speech recognition unit 101 outputs the acquired recognition result to the keyword extraction unit 103, the conversation determination unit 105 and the operation command extraction unit 106.

The keyword extraction unit 103 searches from the recognition-result character string stated in the recognition result acquired in Step ST2, any keyword registered in the keyword storage unit 104 (Step ST3). When the keyword is searched in Step ST3, the keyword extraction unit 103 extracts the obtained keyword (Step ST4). The keyword extraction unit 103 outputs the extraction result in Step ST4 to the conversation determination unit 105 (Step ST5). Thereafter, the processing returns to Step ST1 to thereby repeat the above-described respective processing. Note that, when the keyword extraction unit 103, when it has not extract the keyword in Step ST3, outputs content to the effect that no keyword is extracted, to the conversation determination unit 105.

Next, description will be made about the conversation determination processing by the speech recognition device 100.

FIG. 4 is a flowchart showing operations in the conversation determination processing by the speech recognition device 100 according to Embodiment 1.

The conversation determination unit 105 refers to the keyword extraction result inputted by the processing of Step ST5 shown in the flowchart of FIG. 3, to thereby determine whether or not the speaker's speech is a conversation (Step ST11). When the conversation determination unit 105 has determined that it is not a conversation (Step ST11; NO), it outputs the determination result to the operation command extraction unit 106. The operation command extraction unit 106 refers to the operation command storage unit 107, thereby to extract an operation command from the recognition result of the speech recognition unit 101, and to output it to the navigation device 300 (Step ST12). Thereafter, the processing returns to Step ST11 in the flowchart.

On the other hand, when having determined that the speech is a conversation (Step ST11; YES), the conversation determination unit 105 outputs the determination result to the operation command extraction unit 106. The operation command extraction unit 106 suspends operation command extraction (Step ST13). The operation command extraction unit 106 notifies the conversation determination unit 105 about a fact that the operation command extraction is suspended. The conversation determination unit 105, when it is notified about the fact that the operation command extraction is suspended, acquires from the speech recognition unit 101, information indicating a speech section of a new recognition result (Step ST14). The conversation determination unit 105 measures an interval between the speech section acquired in Step ST14 and another speech section in a recognition result just before the aforementioned speech section (Step ST15).

The conversation determination unit 105 determines whether or not the interval measured in Step ST15 is equal to or less than a preset threshold value (for example, 10 seconds) (Step ST16). When the measured interval is equal to or less than the threshold value (Step ST16; YES), the conversation determination unit 105 estimates that the conversation is continuing (Step ST17) and returns to the processing of Step ST14. In contrast, when the measured interval is more than the threshold value (Step ST16; NO), the conversation determination unit 105 estimates that the conversation has been terminated (Step ST18), and notifies the operation command extraction unit 106 about the termination of the conversation (Step ST19). The operation command extraction unit 106 cancels the suspension of the operation command extraction (Step ST20), and the processing returns to Step ST11.

It is noted that, as processing of Step ST13 in the above-described flowchart of FIG. 4, processing of suspending the operation command extraction has been described; however, such processing may instead be performed in which the operation command extraction unit 106 corrects the recognition score in the recognition result acquired from the speech recognition unit 101 to set so that the operation command is not extracted. In that case, in the processing of Step ST20, the operation command extraction unit 106 cancels the correction of the recognition score.

Further, it is allowable to configure that, in the processing of Step ST12 or Step ST13 in the above-described flowchart of FIG. 4, the operation command extraction unit 106 compares a score indicating a degree of reliability calculated on the basis of a degree of coincidence or the like between the speaker's speech and the operation command, with a preset threshold value, and does not extract the operation command when the scores is equal to or less than the threshold value. Here, the preset threshold value is, for example, a value set to “500” when the maximum value of the score is “1000”.

Furthermore, the operation command extraction unit 106 corrects the score in accordance with the determination result as to whether or not the speaker's speech is a conversation. When the speaker's speech is determined to be a conversation, a correction of that score restrains the operation command from being extracted. When it is determined to be a conversation (Step ST11; YES), the operation command extraction unit 106 subtracts a specified value (for example, “300”) from the value of the score (for example, “600”), and compares a value of the score after subtraction (for example, “300”) with the threshold value (for example, “500”). In this exemplified case, the operation command extraction unit 106 does not extract the operation command from the speaker's speech. In this manner, when the speech is determined to be a conversation, the operation command extraction unit 106 extracts the operation command only from the speaker's speech indicating a high degree of reliability meaning that a command is spoken definitely. Note that, when the speech is determined not to be a conversation (Step ST11; NO), the operation command extraction unit 106 compares the value of the score (for example, “600”), without performing processing of subtracting therefrom the specified value, with the threshold value (for example, “500”). In this exemplified case, the operation command extraction unit 106 extracts the operation command from the speaker's speech.

Further, in Step ST14 to Step ST16, processing has been shown in which, on the basis of the interval between two speech sections, the conversation determination unit 105 estimates whether or not the conversation has been terminated. In addition to performing that processing, the conversation determination unit 105 may estimate that the conversation has been terminated, when a preset time period (for example, 10 seconds or the like) or more has elapsed after the last acquisition of the speech section.

Next, with respect to the flowcharts shown in FIG. 3 and FIG. 4, description will be made citing a specific example. First, it is assumed that, in the keyword storage unit 104, pieces of information, for example, “Mr. A/Ms. A/A”, “Mr. B/Ms. B/B” and the like, are registered. Further, description will be made citing as an example, a case where a conversation of “Ms. A, shall we stop by a convenience store?” is inputted as a speaker's speech.

In Step ST1 in the flowchart of FIG. 3, the collected speaker's speech of “Ms. A, shall we stop by a convenience store?” is inputted. In Step ST2, the speech recognition unit 101 detects the speech section and acquires a recognition-result character string of [Ms. A, shall we stop by a convenience store]. In Step ST3, the keyword extraction unit 103 performs keyword searching on the recognition-result character string. In Step ST4, the keyword extraction unit 103 performs searching with reference to the keyword storage unit 104, to thereby extract a keyword of “Ms. A”. In Step ST5, the keyword extraction unit 103 outputs the extracted keyword “Ms. A” to the conversation determination unit 105.

Then, in Step ST11 in the flowchart of FIG. 4, the conversation determination unit 105, because the keyword is inputted thereto, determines that the speaker's speech is a conversation (Step ST11; YES). In Step ST13, the operation command extraction unit 106 suspends operation command extraction from the recognition-result character string of [Ms. A, shall we stop by a convenience store].

Thereafter, it is assumed that a speaker's speech of “Yes” is inputted to the speech recognition device 100. In Step ST14, the conversation determination unit 105 acquires from the speech recognition unit 101, information about the speech section of the new recognition result of “Yes”. In Step ST15, the conversation determination unit 105 measures the interval between the speech section of the recognition result of “Yes” and the speech section of the recognition result of [Ms. A, shall we stop by a convenience store] to be “3 seconds”. The conversation determination unit 105 determines in Step ST16 that the interval is not more than 10 seconds (Step ST16; YES), and estimates in Step ST17 that the conversation is continuing. Thereafter, the processing returns to Step ST14 in the flowchart.

In contrast, when, in Step ST15, the conversation determination unit 105 has measured the interval between the above-described two speech sections to be “12 seconds”, it determines that the interval is more than 10 seconds (Step ST16; NO), and estimates in Step ST18 that the conversation has been terminated. In Step ST19, the conversation determination unit 105 notifies the operation command extraction unit 106 about the termination of the conversation. In Step ST20, the operation command extraction unit 106 cancels the suspension of the operation command extraction. Thereafter, the processing returns to Step ST14 in the flowchart.

Next, description will be made citing as an example, a case where an operation instruction of “Stop by a convenience store” is inputted as a speaker's speech.

In Step ST1 in the flowchart of FIG. 3, the collected speaker's speech of “Stop by a convenience store” is inputted. In Step ST2, the speech recognition unit 101 detects the speech section and acquires a recognition-result character string of [stop by a convenience store]. In Step ST3, the keyword extraction unit 103 performs keyword searching on the recognition-result character string. In Step ST4, the keyword extraction unit 103 does not perform keyword extraction because any keyword of “Mr. A/Ms. A/A” and “Mr. B/Ms. B/B” is not found. In Step ST5, the keyword extraction unit 103 outputs content to the effect that no keyword is extracted, to the conversation determination unit 105.

Then, in Step ST11 in the flowchart of FIG. 4, the conversation determination unit 105, because no keyword is extracted, determines that the speech is not a conversation (Step ST11; NO). In Step ST12, with reference to the operation command storage unit 107, the operation command extraction unit 106 extracts an operation command of “convenience store” from the recognition-result character string of [stop by a convenience store], and outputs it to the navigation device 300.

In this manner, when the conversation of “Ms. A, shall we stop by a convenience store?” is inputted as a speaker's speech, the operation command extraction is suspended, whereas when the operation instruction of “Stop by a convenience store” is inputted, the operation command extraction is surely executed.

As described above, according to Embodiment 1, it is configured to include: the speech recognition unit 101 for performing speech recognition on a speaker's speech; the keyword extraction unit 103 for extracting a preset keyword from a recognition result of the speech recognition; the conversation determination unit 105 for determining, with reference to an extraction result of such keyword extraction, whether or not the speaker's speech is a conversation; and the operation command extraction unit 106 for extracting a command for operating an apparatus from the recognition result when the speech is determined not to be a conversation, but not extracting the command from the recognition result when the speech is determined to be a conversation. Thus, it is possible to reduce false recognition of the speaker's speech on the basis of the speaker's speech collected by a single sound collection means. Further, it is possible to perform extraction of the command for operating the apparatus without setting the delay time. Further, it is possible to restrain the apparatus from being controlled by a voice operation unintended by the speaker, resulting in increased ease of use.

Further, according to Embodiment 1, it is configured so that, while determining the speaker's speech to be a conversation, the conversation determination unit 105 determines whether or not an interval between the speech sections in the recognition results is equal to or more than a preset threshold value, and estimates that the conversation has been terminated, when the interval between the speech sections is equal to or more than the preset threshold value. Thus, when the termination of the conversation is estimated, it is possible to adequately restart the operation command extraction.

It is noted that the speech recognition device 100 may be configured so that its conversation determination unit 105 outputs the determination result to an external notification device.

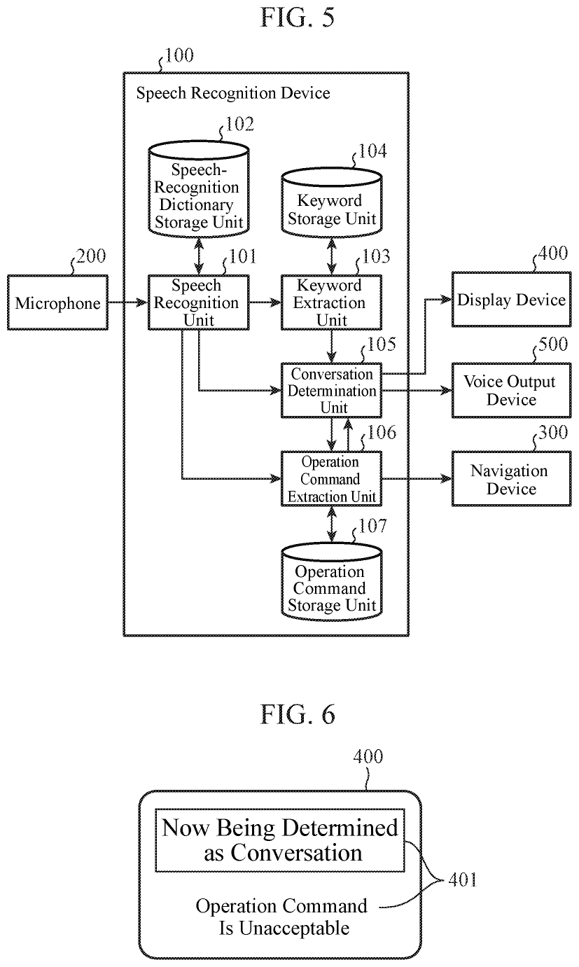

FIG. 5 is a diagram showing another configuration of the speech recognition device 100 according to Embodiment 1.

In FIG. 5, a case is shown where a display device 400 and a voice output device 500, each as the notification device, are connected to the speech recognition device 100.

The display device 400 is configured, for example, with a display, an LED lamp, or the like. The voice output device 500 is configured, for example, with a speaker. The conversation determination unit 105, when having determined that the speech is a conversation, and during when the conversation is continuing, instructs the display device 400 or the voice output device 500 to output notification information.

The display device 400 displays on its display, content to the effect that the speech recognition device 100 has estimated the conversation to be continuing, or has received no operation command. Further, the display device 400 makes a notification indicating that the speech recognition device 100 has estimated the conversation to be continuing, by lighting the LED lamp.

FIG. 6 is a diagram showing a display example of a display screen of the display device 400 connected to the speech recognition device 100 according to Embodiment 1.

When the speech recognition device 100 has estimated the conversation to be continuing, a message 401 of “Now Being Determined as Conversation” and “Operation Command Is Unreceivable”, for example, is displayed on the display screen of the display device 400.

The voice output device 500 outputs a voice guidance or a sound effect indicating that the speech recognition device 100 has estimated the conversation to be continuing, and has received no operation command.

Controlling such an output for notification by the speech recognition device 100 makes the user possible to easily recognize whether the device is in a state capable of receiving an input of the operation command or in a state incapable of receiving that input.

The above-described configuration in which the conversation determination unit 105 outputs the determination result to the external notification device is also applicable to Embodiment 2 and Embodiment 3 to be described later.

Further, the conversation determination unit 105 may store in a storage region (not shown), words indicating termination of conversation, for example, words containing agreement expressions, such as “Let's do so”, “All right”, “OK” and the like.

When the words indicating termination of conversation are included in a newly inputted recognition result, the conversation determination unit 105 may estimates that the conversation has been terminated, without based on the interval between the speech sections.

Namely, the conversation determination unit 105 may be configured to determine, while determining the speaker's speech to be a conversation, whether or not the words indicating termination of conversation are included in the recognition result, and to estimate that the conversation has been terminated, when the words indicating termination of conversation are included therein. This makes it possible to restrain the conversation from being falsely estimated to be continuing because of the interval between the speech sections being detected shorter than the actual interval, due to false detection of the speech section.

### Embodiment 2

In Embodiment 2, such a configuration will be shown in which whether the speech is a conversation or not is determined in additional consideration of a face direction of a user.

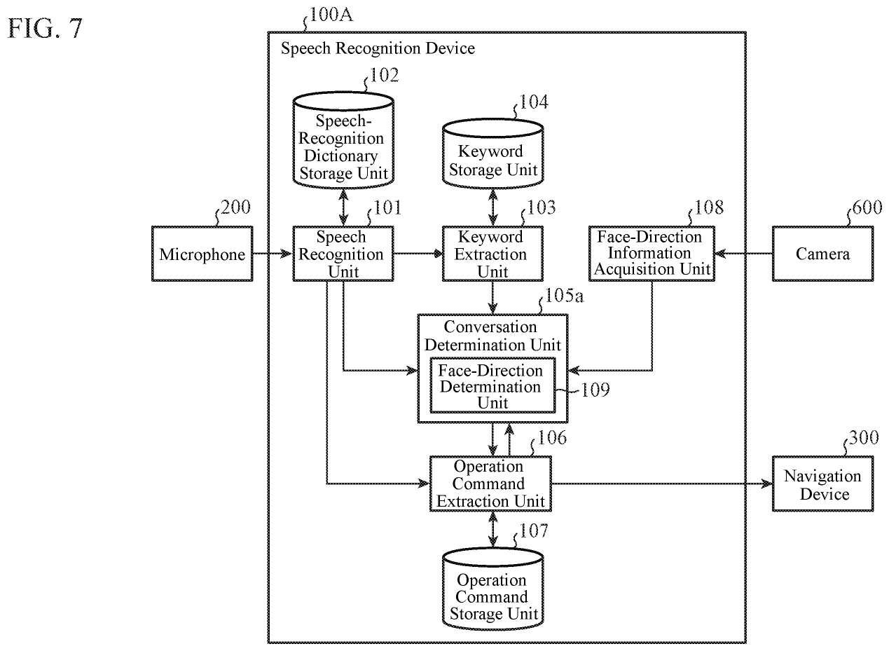

FIG. 7 is a block diagram showing the configuration of a speech recognition device 100A according to Embodiment 2.

The speech recognition device 100A according to Embodiment 2 is configured in such a manner that a face-direction information acquisition unit 108 and a face-direction determination unit 109 are added to the speech recognition device 100 of Embodiment 1 shown in FIG. 1. Further, the speech recognition device 100A is configured in such a manner that a conversation determination unit 105a is provided instead of the conversation determination unit 105 in the speech recognition device 100 of Embodiment 1 shown in FIG. 1.

In the following, for the parts that are the same as or equivalent to the configuration elements of the speech recognition device 100 according to Embodiment 1, the same reference numerals as those used in Embodiment 1 are given, so that description thereof will be omitted or simplified.

The face-direction information acquisition unit 108 analyzes a captured image inputted from an external camera 600, to thereby derive face-direction information of a user existing in the captured image. The face-direction information acquisition unit 108 stores the derived face-direction information in a temporary storage region (not shown) such as a buffer or the like. Here, the user means a capturing-object person captured by the camera 600, who may at least be either a speaker or a person other than the speaker.

The conversation determination unit 105a includes the face-direction determination unit 109. The conversation determination unit 105a, when having determined that the speech is not a conversation between speakers, instructs the face-direction determination unit 109 to acquire the face-direction information. The face-direction determination unit 109 acquires the face-direction information from the face-direction information acquisition unit 108. The face-direction determination unit 109 acquires, as the face-direction information, information of a face direction in a specified time period extending before and after the speaker's speech used in the determination about conversation by the conversation determination unit 105a. The face-direction determination unit 109 determines from the acquired face- direction information, whether or not a conversation has been made. When the acquired face-direction information indicates, for example, a condition that “the face direction of the speaker is toward another user”, “the face direction of a certain user is toward the speaker” or the like, the face-direction determination unit 109 determines that a conversation has been made. Note that, it is possible in any appropriate manner, to determine with what condition the conversation is estimated to have been made, when the face-direction information satisfies said condition.

The conversation determination unit 105a outputs any one of: the result of its determination that a conversation has been made; the result of determination by the face-direction determination unit 109 that a conversation has been made; and the result of determination by the face-direction determination unit 109 that no conversation has been made; to the operation command extraction unit 106.

The operation command extraction unit 106 refers to the determination result inputted from the conversation determination unit 105a and, when the determination result indicates that no conversation has been made, extracts the operation command from the recognition result inputted from the speech recognition unit 101.

In contrast, when the determination result indicates that a conversation has been made, the operation command extraction unit 106 does not extract the operation command from the recognition result inputted from the speech recognition unit 101, or corrects the recognition score stated in the recognition result to set so that the operation command is not extracted.

The conversation determination unit 105a, when having determined that a conversation has been made, and when it is determined by the face-direction determination unit 109 that a conversation has been made, estimates whether the conversation is continuing or the conversation has been terminated, similarly to Embodiment 1.

Next, a hardware configuration example of the speech recognition device 100A will be described. Note that the same configuration as that in Embodiment 1 will be omitted from description.

In the speech recognition device 100A, the conversation determination unit 105a, the face-direction information acquisition unit 108 and the face-direction determination unit 109 correspond to the processing circuit 100a shown in FIG. 2A, or the processor 100b shown in FIG. 2B which executes programs stored in the memory 100c.

Next, description will be made about the conversation determination processing by the speech recognition device 100A. Note that the speech recognition processing by the speech recognition device 100A is the same as that by the speech recognition device 100 of Embodiment 1, so that description thereof will be omitted.

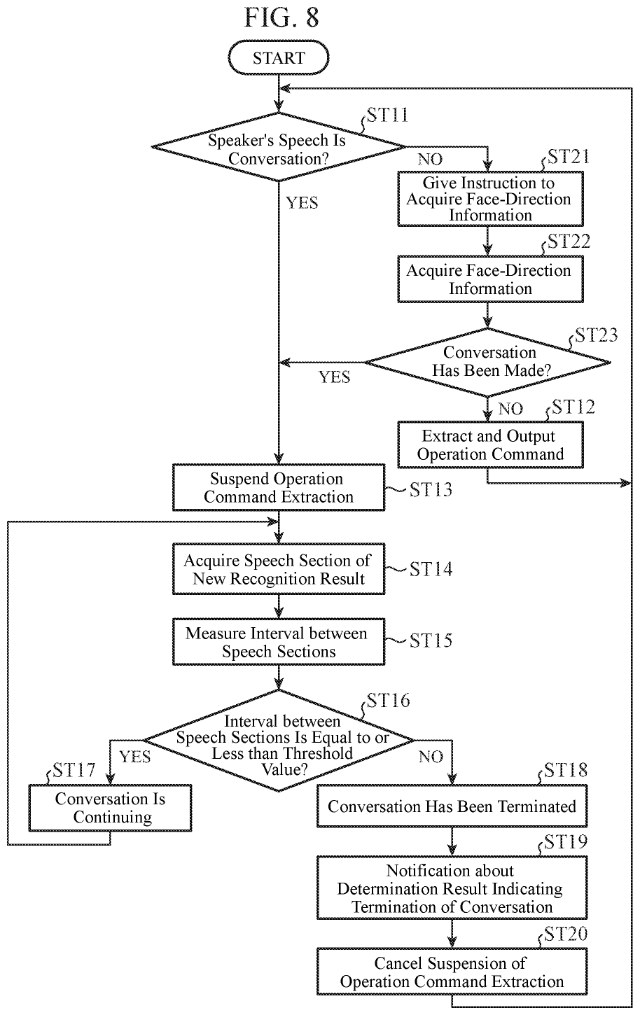

FIG. 8 is a flowchart showing operations in the conversation determination processing by the speech recognition device 100A according to Embodiment 2. In the following, for the steps that are the same as those by the speech recognition device 100 according to Embodiment 1, the same reference numerals as those used in FIG. 4 are given, so that description thereof will be omitted or simplified.

Further, it is assumed that the face-direction information acquisition unit 108 constantly performs processing of acquiring the face-direction information, on the captured image inputted from the camera 600.

In the determination processing of Step ST11, when the conversation determination unit 105a has determined that the speech is not a conversation (Step ST11; NO), the conversation determination unit 105a instructs the face-direction determination unit 109 to acquire the face-direction information (Step ST21).

On the basis of the instruction inputted in Step ST21, the face-direction determination unit 109 acquires from the face-direction information acquisition unit 108, the face-direction information in a specified time period extending before and after the speech section of the recognition result (Step ST22). The face-direction determination unit 109 refers to the face-direction information acquired in Step ST22, to thereby determine whether or not a conversation has been made (Step ST23). When having determined that no conversation has been made (Step ST23; NO), the conversation determination unit 105a outputs the determination result to the operation command extraction unit 106, and moves to the processing of Step ST12. In contrast, when having determined that a conversation has been made (Step ST23; YES), the conversation determination unit 105a outputs the determination result to the operation command extraction unit 106, and moves to the processing of Step ST13.

As described above, according to Embodiment 2, it is configured to include: the face-direction information acquisition unit 108 for acquiring the face-direction information of at least either the speaker or a person other than the speaker; and the face-direction determination unit 109 for further determining, when the conversation determination unit 105a has determined that the speech is not a conversation, whether or not the speaker's speech is a conversation, on the basis of whether or not the face-direction information satisfies a preset condition; wherein the operation command extraction unit 106 extracts the command from the recognition result when the face-direction determination unit 109 has determined that the speech is not a conversation, and does not extract the command from the recognition result when the face-direction determination unit 109 has determined that the speech is a conversation. Thus, it is possible to enhance accuracy in determining whether or not a conversation has been made. This makes it possible to increase ease of use of the speech recognition device.

### Embodiment 3

In Embodiment 3, a configuration will be shown in which a new keyword that may possibly appear in a conversation between speakers is acquired and registered in the keyword storage unit 104.

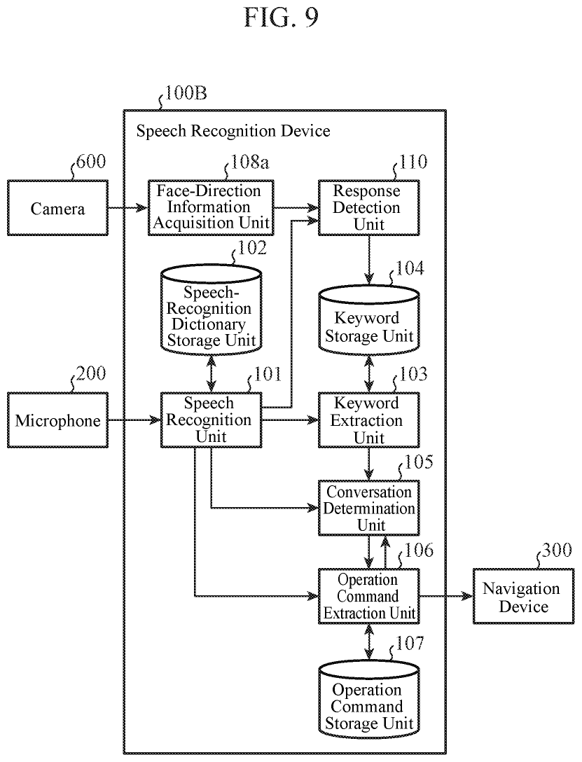

FIG. 9 is a block diagram showing a configuration of a speech recognition device 100B according to Embodiment 3.

The speech recognition device 100B according to Embodiment 3 is configured in such a manner that a face-direction information acquisition unit 108a and a response detection unit 110 are added to the speech recognition device 100 of Embodiment 1 shown in FIG. 1.

In the following, for the parts that are the same as or equivalent to the configuration elements of the speech recognition device 100 according to Embodiment 1, the same reference numerals as those used in Embodiment 1 are given, so that description thereof will be omitted or simplified.

The face-direction information acquisition unit 108a analyzes a captured image inputted from the external camera 600, to thereby derive face-direction information of a user existing in the captured image. The face-direction information acquisition unit 108a outputs the derived face-direction information of the user to the response detection unit 110.

The response detection unit 110 refers to the recognition result inputted from the speech recognition unit 101 to thereby detect a speaker's speech. Within a specified time period after detection of the speaker's speech, the response detection unit 110 determines whether or not it has detected a response of another person. Here, the response of another person means at least either a speech of another person or a change in the face direction of another person.

After detection of the speaker's speech, the response detection unit 110 determines that it has detected a response of another person, when it has detected at least either, with reference to the recognition result inputted from the speech recognition unit 101, an event that a speech response in response to the speech has been inputted, or with reference to the face-direction information inputted from the face-direction information acquisition unit 108a, an event that a change in the face direction in response to the speech has been inputted. The response detection unit 110, when having detected the response of another person, extracts the recognition result of the speaker's speech or a part of that recognition result as a keyword that may possibly appear in a conversation between speakers, and registers it in the keyword storage unit 104.

Next, a hardware configuration example of the speech recognition device 100B will be described. Note that the same configuration as that in Embodiment 1 will be omitted from description.

In the speech recognition device 100B, the face-direction information acquisition unit 108a and the response detection unit 110 correspond to the processing circuit 100a shown in FIG. 2A, or the processor 100b shown in FIG. 2B which executes programs stored in the memory 100c.

Next, description will be made about keyword registration processing by the speech recognition device 100B. Note that the speech recognition processing and the conversation determination processing by the speech recognition device 100B are the same as those in Embodiment 1, so that description thereof will be omitted.

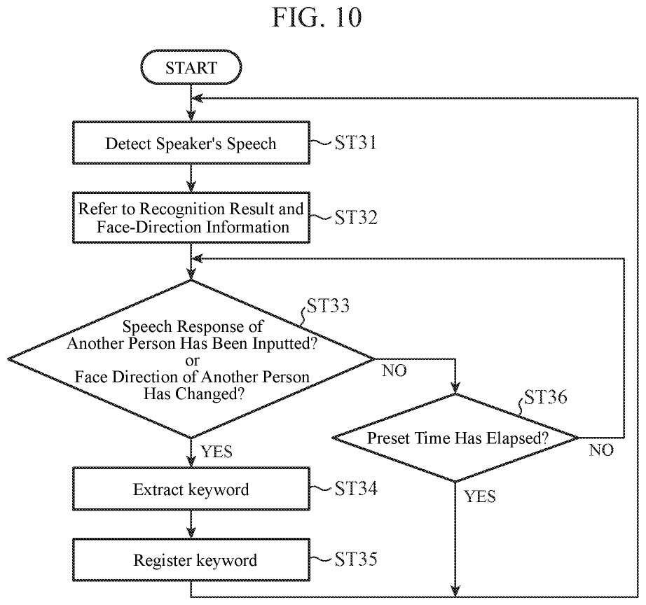

FIG. 10 is a flowchart showing operations in the keyword registration processing by the speech recognition device 100B according to Embodiment 3.

Here, it is assumed that the speech recognition unit 101 constantly performs recognition processing on a speaker's speech inputted from the microphone 200. Likewise, it is assumed that the face-direction information acquisition unit 108a constantly performs processing of acquiring face-direction information, on a captured image inputted from the camera 600.

The response detection unit 110, when having detected a speaker's speech from the recognition result inputted from the speech recognition unit 101 (Step ST31), refers to a recognition result that is inputted subsequently to said speech from the speech recognition unit 101, and the face-direction information that is inputted subsequently to that speech from the face-direction information acquisition unit 108a (Step ST32).

The response detection unit 110 determines whether or not a speech response of another person in response to the speech detected in Step ST31 has been inputted, or whether or not the face direction of another person has changed in response to the detected speech (Step ST33). The response detection unit 110, when having detected at least either an event that a speech response of another person in response to the speech was inputted, or an event that the face direction of another person has changed in response to said speech (Step ST33; YES), extracts a keyword from the speech recognition result detected in Step ST31 (Step ST34). The response detection unit 110 registers the keyword extracted in Step ST34 in the keyword storage unit 104 (Step ST35). Thereafter, the processing returns to Step ST31 in the flowchart

In contrast, the response detection unit 110, when a speech response of another person in response to the detected speech has not been inputted, or the face direction of another person has not changed in response to the detected speech (Step ST33; NO), determines whether or not a preset time has elapsed (Step ST36). When the preset time has not elapsed (Step ST36; NO), the flow returns to the processing of Step ST33. In contrast, when the preset time has elapsed (Step ST36; YES), the flow returns to the processing of Step ST31.

Next, with respect to the flowchart shown in FIG. 10, description will be made citing a specific example. Description will be made citing as an example, a case where a conversation of “Ms. A” is inputted as a speaker's speech.

In Step ST31, from a recognition result “Ms. A” inputted from the speech recognition unit 101, the response detection unit 110 detects a speaker's speech. In Step ST32, the response detection unit 110 refers to a recognition result that is inputted subsequently to the speech of the recognition result “Ms. A” from the speech recognition unit 101, and the face-direction information that is inputted subsequently to that speech from the face-direction information acquisition unit 108a. In Step ST33, the response detection unit 110 determines that a speech response of another person showing a reply of “What?” or the like has been inputted, or that it has detected a change in the face direction caused by another person turning the face toward the speaker (Step ST33; YES). In Step ST34, the response detection unit 110 extracts a keyword of “A” from the recognition result “Ms. A”. In Step ST35, the response detection unit 110 registers the keyword of “A” in the keyword storage unit 104.

In this manner, after the speaker has spoken “Ms. A”, the response detection unit 110 determines whether or not a speech response of another person has been inputted, or whether or not another person has turned the face toward the speaker, so that it is possible to estimate whether or not a conversation has been made between speakers. Accordingly, with respect also to a conversation between previously undefined speakers, the response detection unit 110 extracts a keyword that may possibly appear in the conversation and registers it in the keyword storage unit 104.

As described above, according to Embodiment 3, it is configured to include: the face-direction information acquisition unit 108a for acquiring face-direction information of a person other than the speaker; and the response detection unit 110 for detecting presence/absence of a response of the other person on the basis of at least either the face-direction information of the other person in response to the speaker's speech, or a speech response of the other person in response to the speaker's speech; and for setting, when having detected the response of the other person, the speaker's speech or a part of the speaker's speech, as a keyword. Thus, from the conversation of a user previously unregistered or undefined in the speech recognition device, it is possible to extract and register a keyword that may possibly appear in the conversation. This eliminates the trouble that when the unregistered or undefined user employs the speech recognition device, no determination is performed about his/her conversation. For every user, it is possible to restrain the apparatus from being controlled by a voice operation unintended by the user, to thereby increase ease of use for the user.

It is noted that, in the foregoing, a case has been shown as an example where the face-direction information acquisition unit 108a and the response detection unit 110 are used in the speech recognition device 100 shown in Embodiment 1; however, these units may be used in the speech recognition device 100A shown in Embodiment 2.

It is allowable to configure that some of the functions of the respective components shown in each of the foregoing Embodiment 1 to Embodiment 3 is performed by a server device connected to the speech recognition device 100, 100A or 100B. Furthermore, it is also allowable to configure that all of the functions of the respective components shown in each of Embodiment 1 to Embodiment 3 are performed by the server device.

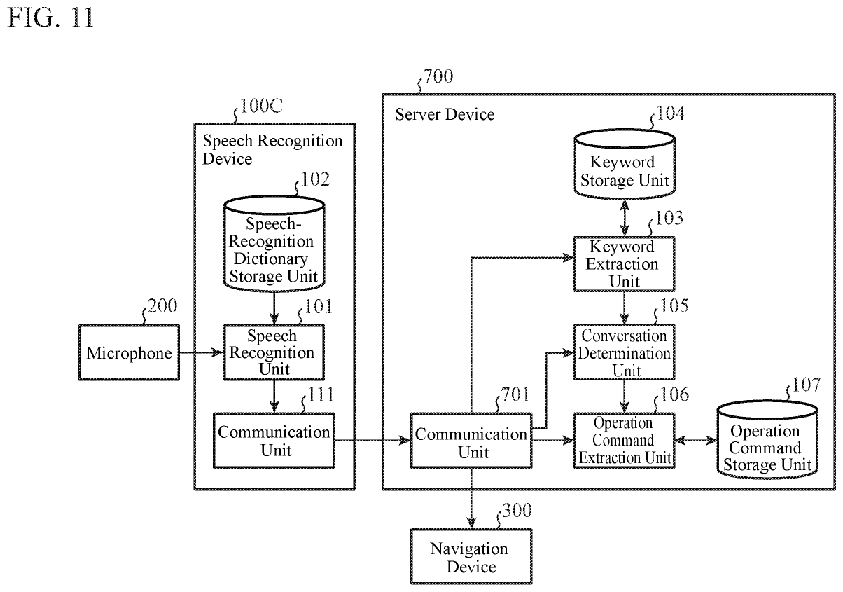

FIG. 11 is a block diagram showing a configuration example in the case where a speech recognition device and a server device cooperatively execute the functions of the respective components shown in Embodiment 1.

A speech recognition device 100C includes the speech recognition unit 101, the speech-recognition dictionary storage unit 102 and a communication unit 111. A server device 700 includes the keyword extraction unit 103, the keyword storage unit 104, the conversation determination unit 105, the operation command extraction unit 106, the operation command storage unit 107 and a communication unit 701. The communication unit 111 of the speech recognition device 100C establishes wireless communication with the server device 700, to thereby transmit the speech recognition result to the server device 700-side. The communication unit 701 of the server device 700 establishes wireless communications with the speech recognition device 100C and the navigation device 300, thereby to acquire the speech recognition result from the speech recognition device 100 and to transmit the operation command extracted from the speech recognition result to the navigation device 300. Note that the control apparatus that makes a wireless-communication connection with the server device 700 is not limited to the navigation device 300.

Other than the foregoing, unlimited combination of the respective embodiments, modification of any configuration element in the embodiments and omission of any configuration element in the embodiments maybe made in the present invention without departing from the scope of the invention.

### INDUSTRIAL APPLICABILITY

The speech recognition device according to the invention is suited to use with an in-vehicle apparatus or the like that receives a voice operation, for extracting the operation command by accurately determining a speech input by the user.

### REFERENCE SIGNS LIST

100, 100A, 100B, 100C: speech recognition device, 101: speech recognition unit, 102: speech-recognition dictionary storage unit, 103: keyword extraction unit, 104: keyword storage unit, 105, 105a : conversation determination unit, 106: operation command extraction unit, 107: operation command storage unit, 108, 108a : face-direction information acquisition unit, 109: face-direction determination unit, 110: response detection unit, 111, 701: communication unit, 700: server device.

1.-8. (canceled)

9. A speech recognition device, comprising:
processing circuitry to perform speech recognition on a speaker's speech;
to extract a preset keyword from a recognition result;
to refer to an extraction result and determine whether the speaker's speech is a conversation; and
to extract a command for operating an apparatus from the recognition result when the processing circuitry determines that the speech is not a conversation, and not extracting to extract the command from the recognition result when the processing circuitry determines that the speech is a conversation,
wherein the preset keyword is a word indicating a personal name or a call.

10. The speech recognition device of claim 9,
wherein the processing circuitry
to acquire face-direction information of at least either a speaker or a person other than the speaker; and
to determine when the processing circuitry determines that the speech is not a conversation, whether the speaker's speech is a conversation, on a basis of whether the acquired face-direction information satisfies a preset condition;
wherein the processing circuitry extracts the command from the recognition result when the processing circuitry has determined that the speech is not a conversation, and does not extract the command from the recognition result when the processing circuitry has determined that the speech is a conversation.

11. The speech recognition device of claim 9,
wherein the processing circuitry
to acquire face-direction information of a person other than a speaker; and
to detect presence or absence of a response of the other person on a basis of at least either the acquired face-direction information of the other person in response to the speaker's speech or a recognized speech response of the other person in response to the speaker's speech; and to set, when having detected the response of the other person, the speaker's speech or a part of the speaker's speech, as the keyword.

12. The speech recognition device of claim 9,
wherein, while determining the speaker's speech to be a conversation, the processing circuitry determines whether an interval between speech sections in the recognition results is equal to or more than a preset threshold value, and estimates that the conversation has been terminated, when the interval between the speech sections is equal to or more than the preset threshold value.

13. The speech recognition device of claim 9,
wherein, while determining the speaker's speech to be a conversation, the processing circuitry determines whether a word indicating termination of conversation is included in the recognition result, and estimates that the conversation has been terminated, when the word indicating termination of conversation is included.

14. The speech recognition device of claim 9, wherein the processing circuitry, when determining that the speaker's speech is a conversation, performs a control to provide notification about a result of the determination.

15. A speech recognition method, comprising:
performing speech recognition on a speaker's speech;
extracting a preset keyword from a recognition result;
referring to an extraction result, and determining whether the speaker's speech is a conversation; and
extracting a command for operating an apparatus from the recognition result when the speech is determined not to be a conversation, and not extracting the command from the recognition result when the speech is determined to be a conversation,
wherein the preset keyword is a word indicating a personal name or a call.
